(19) United States
(12) Patent Application Publication
(10) Pub. No.: US 2014/0356520 A1
(43) Pub. Date: Dec. 4, 2014

(54) Method to enhance sensitivity to surface-normal optical functions of anisotropic films using attenuated total reflection

(71) Applicant: J.A. WOOLLAM CO., INC., Lincoln, NE (US)

(72) Inventors: Thomas E. Tiwald, Lincoln, NE (US); Jeremy A. VanDerslice, Ceresco, NE (US)

(73) Assignee: J.A. WOOLLAM CO., INC., Lincoln, NE (US)

(21) Appl. No.: 14/120,482

(22) Filed: May 22, 2014

Related U.S. Application Data
(60) Provisional application No. 61/855,944, filed on May 28, 2013.

(51) Int. Cl. G01N 21/21

(52) U.S. Cl. CPC G01N 21/211
USPC 427/8

(57) ABSTRACT

Methodology for determining optical functions of thin films with enhanced sensitivity to “p” polarized electromagnetic radiation reflected from both interfaces of an absorbing film.

This application Claims benefit of Provisional Application Ser. No. 61/855,944 filed May 28, 2013.

### TECHNICAL FIELD

The present invention relates to methods for determining optical functions of thin films, and more particularly to methodology for enhancing the sensitivity to “p” polarized electromagnetic radiation reflected from both interfaces of an absorbing film.

### BACKGROUND

It is well known to investigate thin films with electromagnetic radiation. For instance over 160 Patents by the J.A. Woollam company provide great insight to many aspects of the technique. Some of the more relevant thereof as regards the present invention are:
U.S. Pat. Nos. 7,265,839 and 7,920,264 to Tiwald, which discloses a Horizonatally Oriented Attenuation total Reflection system for application in methodology that apply Spectroscopic Ellipsometer or Polarimeter systems;
U.S. Pat. No. 7,636,161 to Tiwald which discloses a system and method for reducing reflections of a beam of electromagnetism from the back surface of a sample;
U.S. Pat. No. 6,738,139 to Synowicki et al., which discloses a method for determining bulk refractive indicies of fluids utilizing thin films thereof on a roughened surface of a two sided rigid or semirigid object;
U.S. Pat. No. 7,777,883 to Synowicki et al., which discloses a system for reducing reflections of a beam of electromagnetic radiation from the back surface of an anisotropic sample, and methodology of for investigating the incident front surface thereof with electromagnetic radiation;
U.S. Pat. No. 7,187,443 to Synowicki et al., which discloses a method for determining bulk refractive indicies of flowable liquids utilizing thin films thereof on a roughened surface of a rigid or semirigid object;
U.S. Pat. No. 7,239,391 to Synowicki et al., which discloses Spectroscopic ellipsometer system mediated methodology for quantifying later defining parameters in mathematical models of samples which contain a plurality of layers of different materials, at least some of which are absorbing of electromagnetic radiation;
U.S. Pat. Nos. 8,531,665, 8,493,565 and 7,817,266 to Pfeiffer et al. which describe small internal volume cells having fluid entry and exit ports for use in ellipsometer systems that cause electromagnetic radiation to reflect from samples therewithin.

Even in view of known prior art, need remains for methods that enable determining optical functions of thin films, and more particularly to methodology for enhancing the sensitivity to “p” polarized electromagnetic radiation reflected from both interfaces of an absorbing film.

### DISCLOSURE OF THE INVENTION

The present invention is method to enhance sensitivity to surface normal optical functions of anisotropic films using attenuated total reflection. It comprising the steps of:

in either order, steps a) and b):

a) providing a transparent prism having three sides, a first and second of which are offset from one another by an apex angle which is sufficient to cause total reflection of an electromagnetic beam entered into the first side of the transparent prism, at the third side of the transparent prism when the ambient is air;

b) providing a transparent substrate having first and second substantially parallel sides separated by a substrate thickness.

The method continues with:

c) depositing a thin film on one side of said substrate; and

d) positioning said third side of said prism which is opposite the apex angle in contact with the side of the substrate opposite that onto which was deposited the thin film.

Actual thin film investigation then involves:

e) causing an incident beam of electromagnetic radiation to enter the first of said two sides of said transparent prism that are offset from one another by said apex angle along a locus that such that said beam passes through said transparent prism and transparent substrate, reflects from said thin film, passes back through said transparent substrate and transparent prism and exists the second side thereof;

f) placing a detector of said electromagnetic radiation at a position such that said beam of electromagnetic radiation that exists said second side of said prism enters thereinto.

Finally properties of the thin film are arrived at by:

g) analyzing data produced by said detector to determine optical properties of said thin film.

Said method can involve refractive index matching material being placed at the point of contact between said transparent substrate and said transparent prism to minimize reflections from said point of contact therebetween. Further, the refractive index matching material is typically a fluid.

Said method can involve the transparent prism and transparent substrate being merged into a single element with the thin film being deposited onto the third side of the transparent prism that is opposite the apex degree angle.

The transparent prism having three sides, a first and second of which are offset from one another by said apex can be modified such that the apex angle is cut away therefrom thereby providing a fourth side which is typically, but not necessarily, substantially parallel to said side of said transparent prism which was opposite said cut away apex angle which is positioned on the side of said transparent substrate opposite to that upon which was deposited a thin film.

Further, the transparent prism which is modified by removal of said apex angle to provide said fourth side, can be hollow and inside of which there is caused to be present a fluid. For that matter, the apex angle can remain in place and the prism be hollow with a liquid being present therewithin.

The present method works best when the electromagnetic beam is polarized to comprise a “p” component, and it is the selectively the “p” component that is analyzed in step g.

Another method to enhance sensitivity to surface normal optical functions of anisotropic films using attenuated total reflection comprising the steps of:

a) providing a transparent prism having three sides, a first and second of which are offset from one another by an apex angle which is sufficient to cause total reflection of an electromagnetic beam entered into the first side of the transparent prism, at the third side of the transparent prism when the ambient is air.

The method continues with:

b) depositing a thin film on the third side of said prism which is opposite said apex angle.

Actual thin film investigation then involves:

c) causing an incident beam of electromagnetic radiation to enter the first of said two sides of said transparent prism that are offset from one another by said apex angle, along a locus such that said beam passes through said transparent prism, reflects from said thin film, passes back through said transparent prism and exists the second side thereof; and

f) placing a detector of said electromagnetic radiation at a position such that said beam of electromagnetic radiation that exists said second side of said prism enters thereinto.

Finally properties of the thin film are arrived at by:

g) analyzing data produced by said detector to determine optical properties of said thin film.

Said method can involve the transparent prism having three sides, a first and second of which are offset from one another by said apex angle is modified such that the apex angle is cut away therefrom thereby providing a fourth side which is typically, but not necessarily, substantially parallel to said side of said transparent prism which was opposite said cut away apex angle.

Said method can involve that the transparent prism which is modified by removal of said apex angle to provide said fourth side, is hollow and inside of which there is caused to be present a fluid.

And said method can involve that the electromagnetic beam is polarized to comprise a “p” component, and it is the selectively the “p” component that is analyzed in step g.

Another modified method to enhance sensitivity to surface normal optical functions of anisotropic films using attenuated total reflection comprising the steps of:

in either order, steps a) and b):

a) providing a flat transparent substrate having two sides separated by a substrate thickness, said two sides being substantially parallel to one another;

b) providing a sensitivity enhancement system comprising what can be described as a transparent prism having three sides, a first and second of which are offset from one another by an apex angle, but from which the apex angle has been removed thereby providing a fourth side that is typically, but not necessarily, substantially parallel to the third side that was opposite the removed apex angle, and wherein said apex angle is sufficient to cause total reflection of an electromagnetic beam entered into the first side of the transparent prism, at the third side of the transparent prism when the ambient is air.

The method continues with:

c) depositing a thin film on one of said two sides of said substrate;

d) positioning the third side of said sensitivity enhancing system, on the side of said transparent substrate opposite to that upon which was deposited a thin film.

Actual thin film investigation then involves:

e) causing an incident beam of electromagnetic radiation to enter a first of said two sides of said sensitivity enhancing system that are offset from one another by said apex angle, along a locus that causes it to enter said first side, such that said beam passes through said transparent prism and said transparent substrate, reflects from said thin film, passes back through said transparent substrate and transparent prism and exists the second side thereof;

f) causing said electromagnetic radiation to enter a detector of electromagnetic radiation which is positioned such that said beam of electromagnetic radiation that reflected from said thin film and existed said second side of said prism enters thereinto.

Finally properties of the thin film are arrived at by:

g) analyzing data produced by said detector to determine optical properties of said thin film with enhanced sensitivity.

Said method can involve that refractive index matching material is placed at the point of contact between said transparent substrate and said third side to minimize reflections from said point of contact therebetween, and said refractive index matching material can be a fluid.

Said method can involve that the transparent substrate and said transparent prism from which is removed the apex angle are physically merged into one another such that said transparent substrate is a part of said transparent sensitivity enhancement system, and the thin film is directly deposited onto the third side thereof.

Said method can involve the transparent prism being modified by removal of said apex angle to provide said fourth side, is hollow and inside of which there is caused to be present a fluid.

And said method can involve that the electromagnetic beam is polarized to comprise a “p” component, and it is selectively the “p” component that is analyzed.

Another modified method to enhance sensitivity to surface normal optical functions of anisotropic films using attenuated total reflection comprising the steps of:

a) providing a sensitivity enhancing system which can be described as comprising a transparent prism having three sides, a first and second of which are offset from one another by an apex angle, but which is modified such that the apex angle is cut away therefrom thereby providing a fourth side which is typically, but not necessarily, substantially parallel to said third side of said transparent prism which would be opposite said cut away apex angle were it not removed, and wherein the apex angle is sufficient to cause total reflection of an electromagnetic beam entered into the first side of the transparent prism, at the third side of the transparent prism when the ambient is air.

The method continues with:

b) depositing a thin film on the third side of said sensitivity enhancing system.

Actual thin film investigation then involves:

c) causing an incident beam of electromagnetic radiation to enter the first of said two sides of said transparent prism that are offset from one another by said apex angle along a locus such that said beam passes through said sensitivity enhancing system, reflects from said thin film, passes back through said sensitivity enhancing system and exists the second side thereof; and

f) placing a detector of said electromagnetic radiation at a position such that said beam of electromagnetic radiation that exists said second side of said sensitivity enhancing system.

Finally properties of the thin film are arrived at by:

g) analyzing data produced by said detector to determine optical properties of said thin film.

Said method can involve that the transparent prism which is modified by removal of said apex angle to provide said fourth side, is hollow and inside of which there is caused to be present a fluid.

Said method an involve that the electromagnetic beam is polarized to comprise a “p” component, and it is the selectively the “p” component that is analyzed in step g.

In any of the methodologies the electromagnetic beam can be directed at the first side of the transparent prism at an angle selected from the group consisting of any angle between 0.0 and 90 degrees that causes that angle internally incident on the third face to be greater than the critical angle

sin(critical angle)>n(air)/n(prism)

where “n” is refractive index. Said angles can include:
45, 55, 65, 75 and 90 degrees.

The present invention will be better understood by reference to the Detailed Description Section of this Specification, in conjunction with the Drawings.

### BRIEF DESCRIPTION OF THE DRAWINGS

FIGS. 1 and 2 show a transparent prism having three sides, and a separate substrate upon one side thereof is deposited a thin film.

FIG. 3 shows a system similar to that in FIGS. 1 and 2, but indicates that the prism and substrate have been effectively merged into one another.

FIG. 4 shows a sensitivity enhancement system comprising a three sided prism, a first and second of which sides are offset from one another by an apex angle, but from which the apex angle has been removed.

FIG. 5a shows a transparent Prism applied to acquire the data in FIGS. 5b and 5c.

FIGS. 5b and 5c show differences in Fresnel Magnitudes and Psi Degrees, respectively, between isotropic and anisotropic data collected using the system of FIG. 5a.

FIG. 5d shows a system used to acquire data presented in FIGS. 5e and 5f.

FIGS. 5e and 5f show differences in Fresnel Magnitudes and Psi Degrees, respectively, between isotropic and anisotropic data collected using the system of FIG. 5c.

FIGS. 6a and 6b show Refractive Index and Extinction Coefficient for Ordinary and Extraordinary Prism-ATR data.

### DETAILED DESCRIPTION

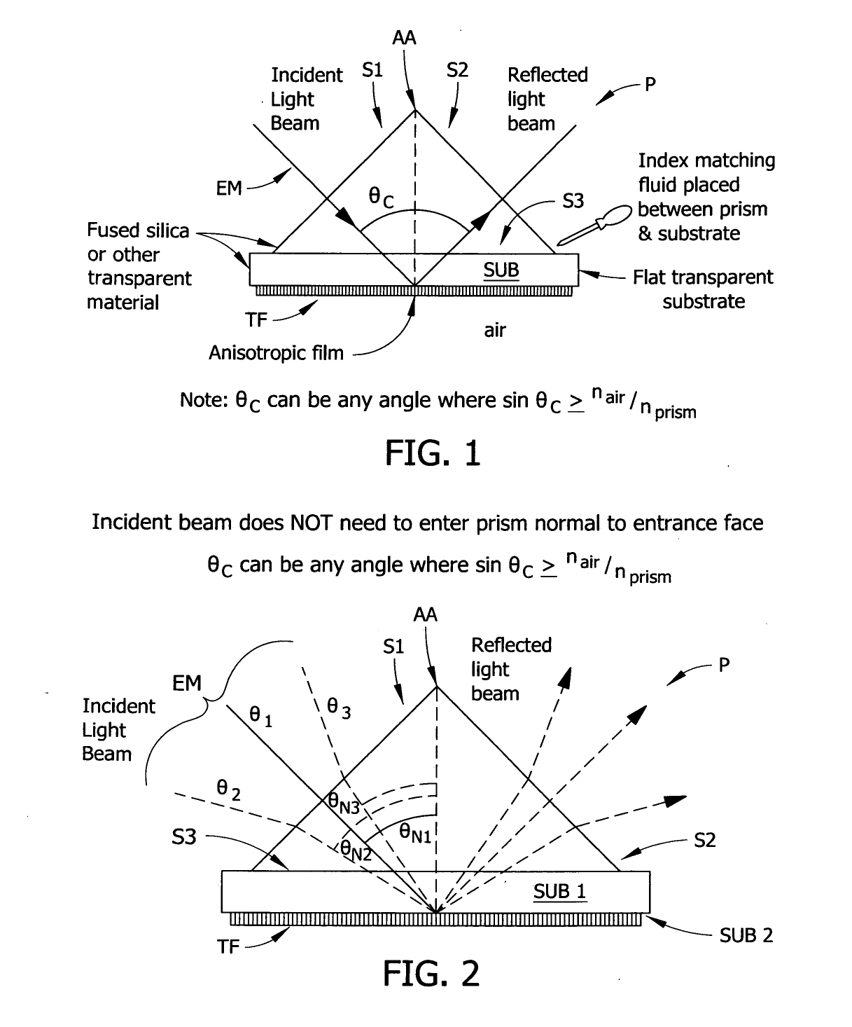

Turning now to the Drawings, FIGS. 1 and 2 show a transparent prism (P) having three sides, a first (S1) and second (S2) of which are offset from one another by an apex angle (AA) which is sufficient to cause total reflection of an electromagnetic beam entered into the first side (S1) of the transparent prism (P), at the third side (S3) of the transparent prism when the ambient is air, and a transparent substrate (SUB) having first and second substantially parallel sides separated by a substrate thickness. Note that a thin film (TF) is deposited on one side (SBU2) of said substrate (SUB), and that said third side (S3) of said prism (P), which is opposite the apex angle (AA), is in contact with the side (SUB1) of the substrate (SUB) opposite that onto which was deposited the thin film (TF).

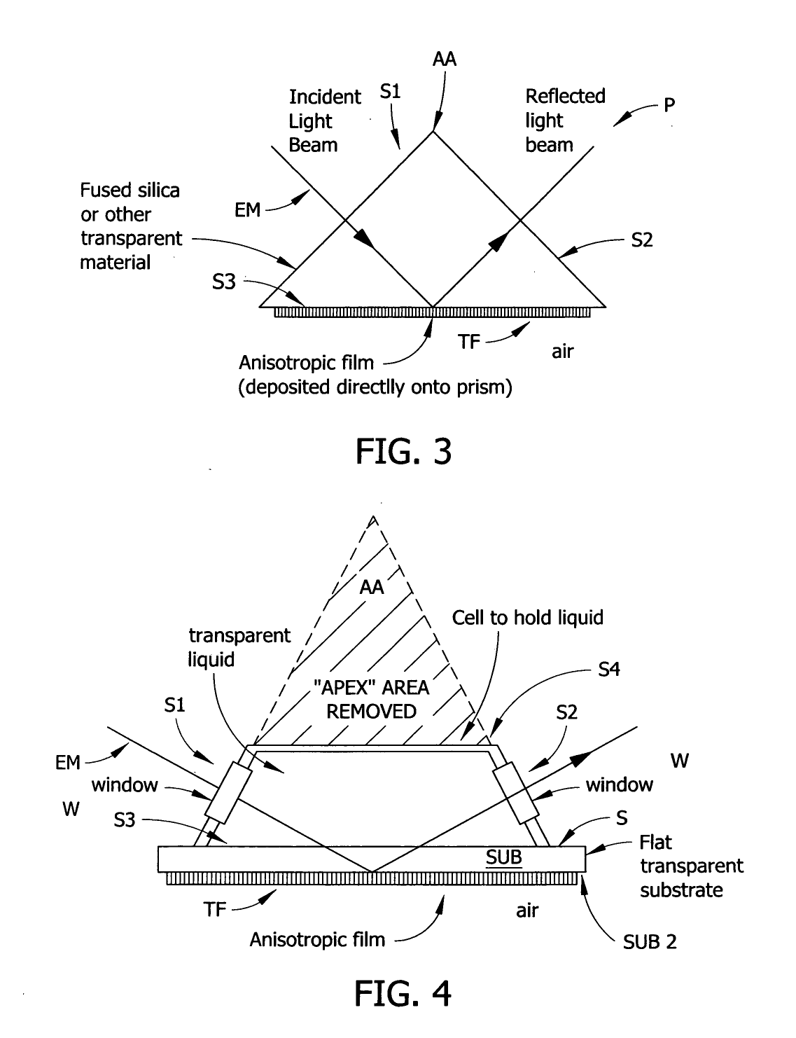

FIG. 3 shows a system similar to that in FIGS. 1 and 2, but indicates that the prism (P) and substrate (SUB) have been effectively merged into one another, in that the thin film (TF) is deposited directly on the third side (S3) of the prism (P).

FIG. 4 shows a sensitivity enhancement system comprising what can be described as a transparent prism having three sides, a first (S1) and second of which are offset from one another by an apex angle (AA), but from which the apex angle (AA) has been removed thereby providing a fourth side (S4) that is typically, but not necessarily, substantially parallel to the third side (S3) that was opposite the removed apex angle (AA), and wherein said apex angle (AA) is sufficient to cause total reflection of an electromagnetic beam (EM) entered into the first side (S1) of the transparent prism (P), at the third side (S3) of the transparent prism (P) when the ambient is air. Note that electromagnetic radiation transparent “windows” (W) are also indicated, but are not required where the prism material is transparent thereto.

Again, the sensitivity enhancing system can be separate from a substrate and set atop a substrate on a side thereof opposite to that upon which is deposited a thin film, or the thin film can be directly deposited onto the third side thereof which is opposite the removed apex angle region.

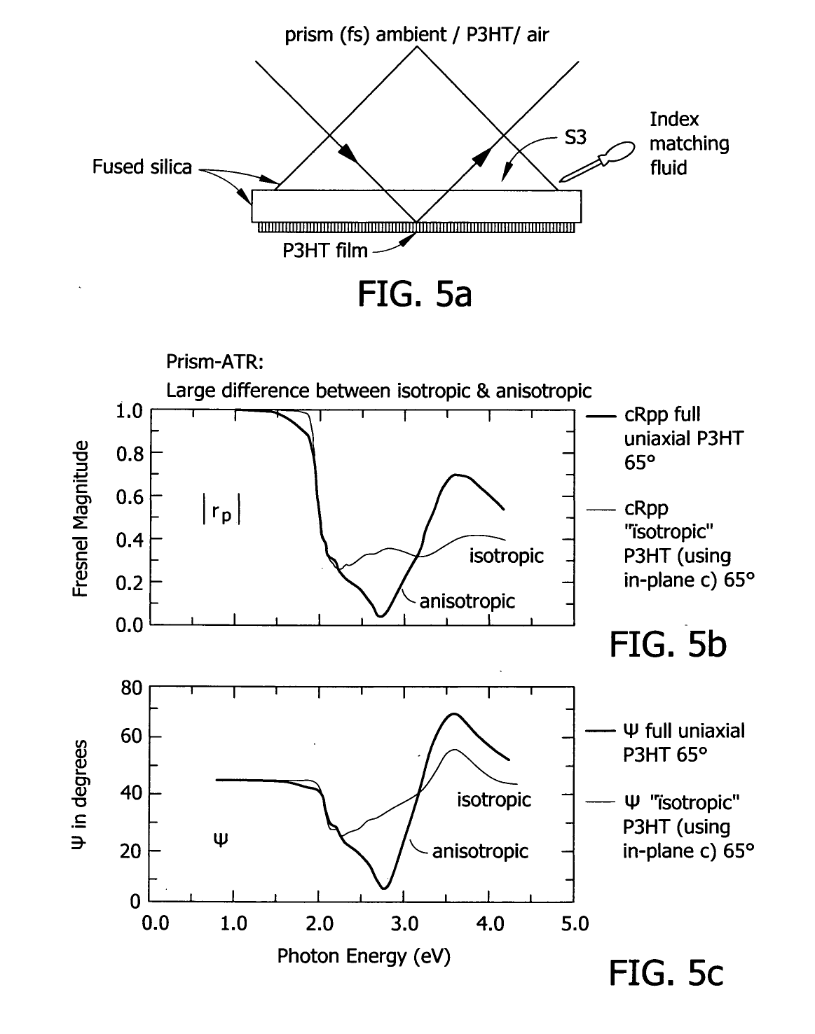

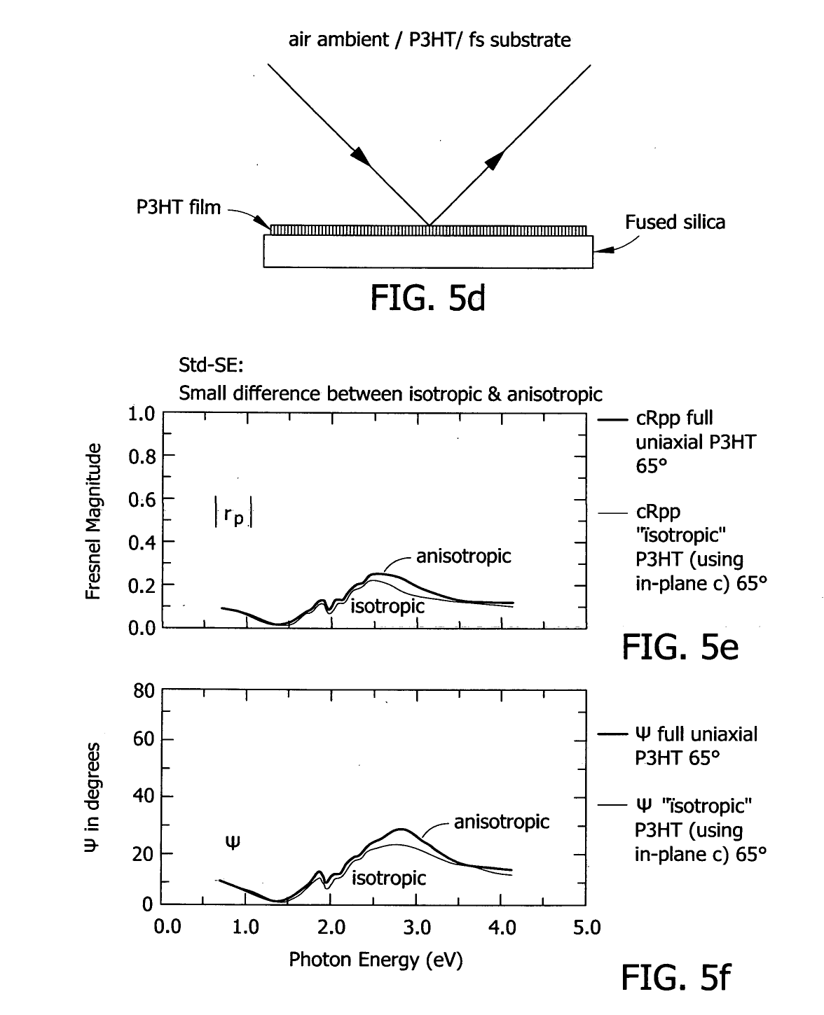

FIG. 5a shows a transparent Prism applied to acquire the data in FIGS. 5b and 5c. FIGS. 5b and 5c show differences in Fresnel Magnitudes and Psi Degrees, respectively, between isotropic and anisotropic data collected using the system of FIG. 5a.

FIG. 5d shows a system used to acquire data presented in FIGS. 5e and 5f. FIGS. 5e and 5f show differences in Fresnel Magnitudes and Psi Degrees, respectively, between isotropic and anisotropic data collected using the system of FIG. 5c.

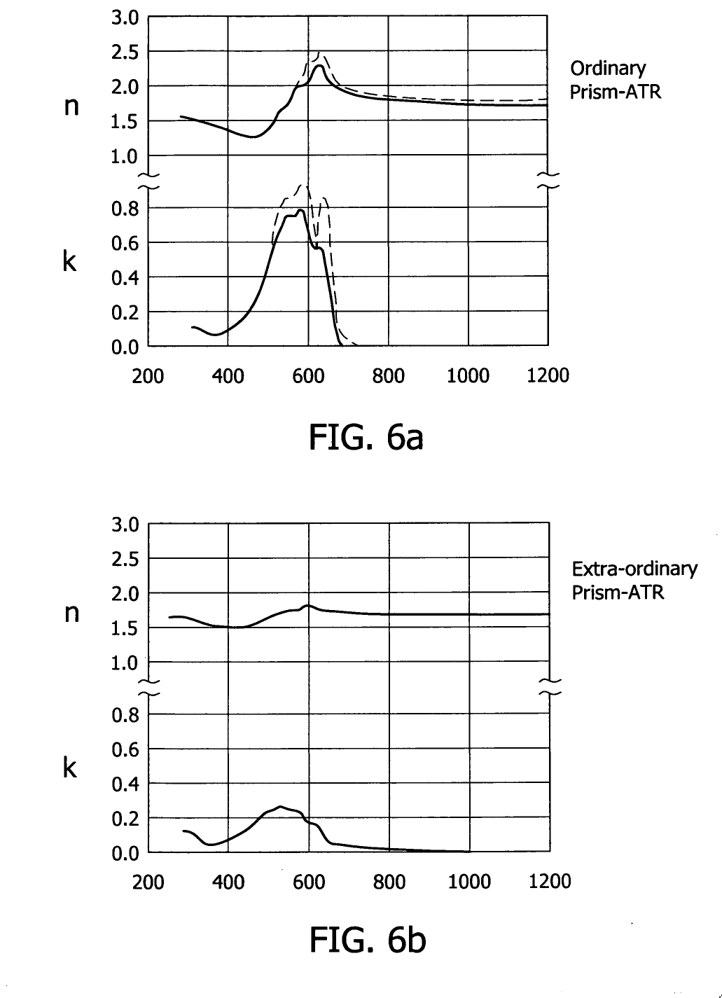

FIGS. 6a and 6b show Refractive Index and Extinction Coefficient for Ordinary and Extraordinary Prism-ATR data.

Having hereby disclosed the subject matter of the present invention, it should be obvious that many modifications, substitutions, and variations of the present invention are possible in view of the teachings. It is therefore to be understood that the invention may be practiced other than as specifically described, and should be limited in its breadth and scope only by the Claims.

We claim:

1. A method to enhance sensitivity to surface normal optical functions of anisotropic films using attenuated total reflection comprising the steps of:
in either order, steps a) and b):
a) providing a transparent prism having three sides, a first and second of which are offset from one another by an apex angle which is sufficient to cause total reflection of an electromagnetic beam entered into the first side of the transparent prism, at the third side of the transparent prism when the ambient is air;
b) providing a transparent substrate having first and second substantially parallel sides separated by a substrate thickness;
c) depositing a thin film on one side of said substrate;
d) positioning said third side of said prism which is opposite the apex angle in contact with the side of the substrate opposite that onto which was deposited the thin film;
e) causing an incident beam of electromagnetic radiation to enter the first of said two sides of said transparent prism that are offset from one another by said apex angle along a locus that such that said beam passes through said transparent prism and transparent substrate, reflects from said thin film, passes back through said transparent substrate and transparent prism and exists the second side thereof;
f) placing a detector of said electromagnetic radiation at a position such that said beam of electromagnetic radiation that exists said second side of said prism enters thereinto;
g) analyzing data produced by said detector to determine optical properties of said thin film.

2. A method as in claim 1 in which refractive index matching material is placed at the point of contact between said transparent substrate and said transparent prism to minimize reflections from said point of contact therebetween.

3. A method as in claim 1 in which said refractive index matching material is a fluid.

4. A method as in claim 1 in which the transparent prism and transparent substrate are merged into a single element and the thin film is deposited onto the third side of the transparent prism that is opposite the apex degree angle.

5. A method as in claim 1 in which the transparent prism having three sides, a first and second of which are offset from one another by said apex is modified such that the apex angle is cut away therefrom thereby providing a fourth side which is typically, but not necessarily, substantially parallel to said side of said transparent prism which was opposite said cut away apex angle which is positioned on the side of said transparent substrate opposite to that upon which was deposited a thin film.

6. A method as in claim 4 in which the transparent prism which is modified by removal of said apex angle to provide said fourth side, is hollow and inside of which there is caused to be present a fluid.

7. A method as in claim 1 in which the electromagnetic beam is polarized to comprise a “p” component, and it is the selectively the “p” component that is analyzed in step g.

8. A method to enhance sensitivity to surface normal optical functions of anisotropic films using attenuated total reflection comprising the steps of:
a) providing a transparent prism having three sides, a first and second of which are offset from one another by an apex angle which is sufficient to cause total reflection of an electromagnetic beam entered into the first side of the transparent prism, at the third side of the transparent prism when the ambient is air;
b) depositing a thin film on the third side of said prism which is opposite said apex angle;
c) causing an incident beam of electromagnetic radiation to enter the first of said two sides of said transparent prism that are offset from one another by said apex angle, along a locus such that said beam passes through said transparent prism, reflects from said thin film, passes back through said transparent prism and exists the second side thereof;
f) placing a detector of said electromagnetic radiation at a position such that said beam of electromagnetic radiation that exists said second side of said prism enters thereinto;
g) analyzing data produced by said detector to determine optical properties of said thin film.

9. A method as in claim 8 in which the transparent prism having three sides, a first and second of which are offset from one another by said apex angle is modified such that the apex angle is cut away therefrom thereby providing a fourth side which is typically, but not necessarily, substantially parallel to said side of said transparent prism which was opposite said cut away apex angle.

10. A method as in claim 9 in which the transparent prism which is modified by removal of said apex angle to provide said fourth side, is hollow and inside of which there is caused to be present a fluid.

11. A method as in claim 8 in which the electromagnetic beam is polarized to comprise a “p” component, and it is the selectively the “p” component that is analyzed in step g.

12. A method to enhance sensitivity to surface normal optical functions of anisotropic films using attenuated total reflection comprising the steps of:
in either order, steps a) and b):
a) providing a flat transparent substrate having two sides separated by a substrate thickness, said two sides being substantially parallel to one another;
b) providing a sensitivity enhancement system comprising what can be described as a transparent prism having three sides, a first and second of which are offset from one another by an apex angle, but from which the apex angle has been removed thereby providing a fourth side that is typically, but not necessarily, substantially parallel to the third side that was opposite the removed apex angle, and wherein said apex angle is sufficient to cause total reflection of an electromagnetic beam entered into the first side of the transparent prism, at the third side of the transparent prism when the ambient is air;
c) depositing a thin film on one of said two sides of said substrate;
d) positioning the third side of said sensitivity enhancing system, on the side of said transparent substrate opposite to that upon which was deposited a thin film;
e) causing an incident beam of electromagnetic radiation to enter a first of said two sides of said sensitivity enhancing system that are offset from one another by said apex angle, along a locus that causes it to enter said first side, such that said beam passes through said transparent prism and said transparent substrate, reflects from said thin film, passes back through said transparent substrate and transparent prism and exists the second side thereof;
f) causing said electromagnetic radiation to enter a detector of electromagnetic radiation which is positioned such that said beam of electromagnetic radiation that reflected from said thin film and existed said second side of said prism enters thereinto;
g) analyzing data produced by said detector to determine optical properties of said thin film with enhanced sensitivity.

13. A method as in claim 12 in which refractive index matching material is placed at the point of contact between said transparent substrate and said third side to minimize reflections from said point of contact therebetween.

14. A method as in claim 13 in which said refractive index matching material is a fluid.

15. A method as in claim 12 in which said transparent substrate and said transparent prism from which is removed the apex angle are physically merged into one another such that said transparent substrate is a part of said transparent sensitivity enhancement system, and the thin film is directly deposited onto the third side thereof.

16. A method as in claim 12 in which the transparent prism which is modified by removal of said apex angle to provide said fourth side, is hollow and inside of which there is caused to be present a fluid.

17. A method as in claim 12 in which the electromagnetic beam is polarized to comprise a “p” component, and it is selectively the “p” component that is analyzed.

18. A method to enhance sensitivity to surface normal optical functions of anisotropic films using attenuated total reflection comprising the steps of:
a) providing a sensitivity enhancing system which can be described as comprising a transparent prism having three sides, a first and second of which are offset from one another by an apex angle, but which is modified such that the apex angle is cut away therefrom thereby providing a fourth side which is typically, but not necessarily, substantially parallel to said third side of said transparent prism which would be opposite said cut away apex angle were it not removed, and wherein the apex angle is sufficient to cause total reflection of an electromagnetic beam entered into the first side of the transparent prism, at the third side of the transparent prism when the ambient is air;
b) depositing a thin film on the third side of said sensitivity enhancing system;
c) causing an incident beam of electromagnetic radiation to enter the first of said two sides of said transparent prism that are offset from one another by said apex angle along a locus such that said beam passes through said sensitivity enhancing system, reflects from said thin film, passes back through said sensitivity enhancing system and exists the second side thereof;
f) placing a detector of said electromagnetic radiation at a position such that said beam of electromagnetic radiation that exists said second side of said sensitivity enhancing system;
g) analyzing data produced by said detector to determine optical properties of said thin film.

19. A method as in claim 18 in which the transparent prism which is modified by removal of said apex angle to provide said fourth side, is hollow and inside of which there is caused to be present a fluid.

20. A method as in claim 18 in which the electromagnetic beam is polarized to comprise a “p” component, and it is the selectively the “p” component that is analyzed in step g.

21. A method as in claim 1, wherein the electromagnetic beam is directed at the first side of the transparent prism at any angle between 0.0 and 90 degrees that causes that angle internally incident on the third face to be greater than the critical angle
sin(critical angle)>n(air)/n(prism).

22. A method as in claim 8, wherein the electromagnetic beam is directed at the first side of the transparent prism at any angle between 0.0 and 90 degrees that causes that angle internally incident on the third face to be greater than the critical angle
sin(critical angle)>n(air)/n(prism).

23. A method as in claim 12, wherein the electromagnetic beam is directed at the first side of the transparent prism at any angle between 0.0 and 90 degrees that causes that angle internally incident on the third face to be greater than the critical angle
sin(critical angle)>n(air)/n(prism).

24. A method as in claim 18, wherein the electromagnetic beam is directed at the first side of the transparent prism at any angle between 0.0 and 90 degrees that causes that angle internally incident on the third face to be greater than the critical angle
sin(critical angle)>n(air)/n(prism).

25. A method as in claim 1 where the transparent prism is hollow and there is a liquid present therewithin.

26. A method as in claim 8 where the transparent prism is hollow and there is a liquid present therewithin.
